(19) United States
(12) Patent Application Publication
(10) Pub. No.: US 2020/0354656 A1
(43) Pub. Date: Nov. 12, 2020

(54) CLEANING LIQUID

(71) Applicant: DAIDO METAL CO., LTD., NAGOYA-SHI, AICHI (JP)

(72) Inventor: Takashi IAI, INUYAMA-SHI, AICHI (JP)

(21) Appl. No.: 16/760,214

(22) PCT Filed: Nov. 8, 2018
(86) PCT No.: PCT/JP2018/041489

§ 371 Date: Apr. 29, 2020

(30) Foreign Application Priority Data
Nov. 20, 2017 (JP) 2017-223179

(51) Int. Cl. C11D 17/00; C11D 7/02; B01F 3/04; B01F 15/06; B01F 3/08; B08B 3/10

(52) U.S. Cl. CPC C11D 17/0043; C11D 7/02; B01F 3/04106; B01F 2215/004; B01F 3/08; B08B 3/10; B01F 15/066

(57) ABSTRACT

A cleaning liquid includes a static liquid (13), a second fine gas bubble group (26) contained in the static liquid (13) and formed by a gas at a first temperature, a dynamic liquid (22) that flows toward an object to be cleaned (W) that is held in the static liquid (13), and a second fine gas bubble group (26) formed by a gas at a second temperature different from the first temperature, the second fine gas bubble group (26) being entrapped by a flow of the dynamic liquid (22) and flowing toward the object to be cleaned (W). This makes it possible to provide a cleaning liquid that exhibits a cleaning effect remarkably better than ever before.

### TECHNICAL FIELD

The present invention relates to a cleaning liquid containing a fine gas bubble group in a liquid.

### BACKGROUND ART

Patent Document 1 discloses a cleaning liquid. The cleaning liquid contains nano-size gas bubbles dissolved in a liquid at a saturation dissolution concentration. Patent Document 1 focuses on the hydrogen bonding distance of the liquid molecules in order to improve the cleaning effect.

### PRIOR ART DOCUMENTS

### Patent Documents

Patent Document 1: Japanese Patent Application Laid-open No. 2011-88979

### SUMMARY OF THE INVENTION

### Problems to be Solved by the Invention

Patent Document 1 in addition focuses on external forces that collapse gas bubbles. Such external forces include pressure change, temperature change, shock waves, ultrasonic waves, infrared radiation and vibration. It is surmised that the collapse of gas bubbles contributes to an improvement in the cleaning power.

An object of the present invention is to provide a cleaning liquid that exhibits a cleaning effect remarkably better than ever before.

### Means for Solving the Problems

According to a first aspect of the present invention, there is provided a cleaning liquid comprising a static liquid, a first fine gas bubble group contained in the static liquid and formed by a gas at a first temperature, a dynamic liquid that flows toward an object held in the static liquid, and a second fine gas bubble group formed by a gas at a second temperature that is different from the first temperature, the second fine gas bubble group being entrapped by a flow of the dynamic liquid and flowing toward the object.

### Effects of the Invention

In accordance with the first aspect, when an object makes contact with the cleaning liquid, the first fine gas bubble group and the second fine gas bubble group act one after another on the border (the contour of the interface) between the surface of the object and a substance (e.g. contaminant) adhering to the surface of the object. Due to the gas at a first temperature and the gas at a second temperature acting on the same position, the temperature repeatedly changes at the contour of the interface (the temperature oscillates). The oscillation of the temperature causes detachment at the interface.

Accompanying the progress of detachment the gas penetrates into the inside from the contour. In this way, the substance becomes detached from the surface of the object. The substance is separated from the object. By virtue of the action of the temperature oscillation, the cleaning liquid exhibits a cleaning effect remarkably better than ever before even without necessarily using the energy of collapsing gas bubbles.

### BRIEF DESCRIPTION OF DRAWINGS

FIG. 1 is a conceptual diagram showing an overall picture of a cleaning device related to a first embodiment of the present invention. (first embodiment)

FIG. 2 is a graph showing the distribution of gas bubble number with respect to each gas bubble diameter. (first embodiment)

FIG. 3 is a conceptual diagram showing an overall picture of a cleaning device related to a second embodiment of the present invention. (second embodiment)

FIG. 4 is a graph showing the relationship between temperature conditions and weight of swarf remaining. (second embodiment)

FIG. 5 is a graph showing the relationship between temperature conditions and concentration of oil recovered in a solvent. (second embodiment)

### EXPLANATION OF REFERENCE NUMERALS AND SYMBOLS

13 Static liquid
16 First fine gas bubble group
22 Dynamic liquid
26 Second fine gas bubble group
43 Static liquid
44 First fine gas bubble group
47 Dynamic liquid
52 Second fine gas bubble group
W Object (object to be cleaned)

### MODES FOR CARRYING OUT THE INVENTION

Embodiments of the present invention are explained below by reference to the attached drawings.

### (1) Cleaning Device Related to First Embodiment

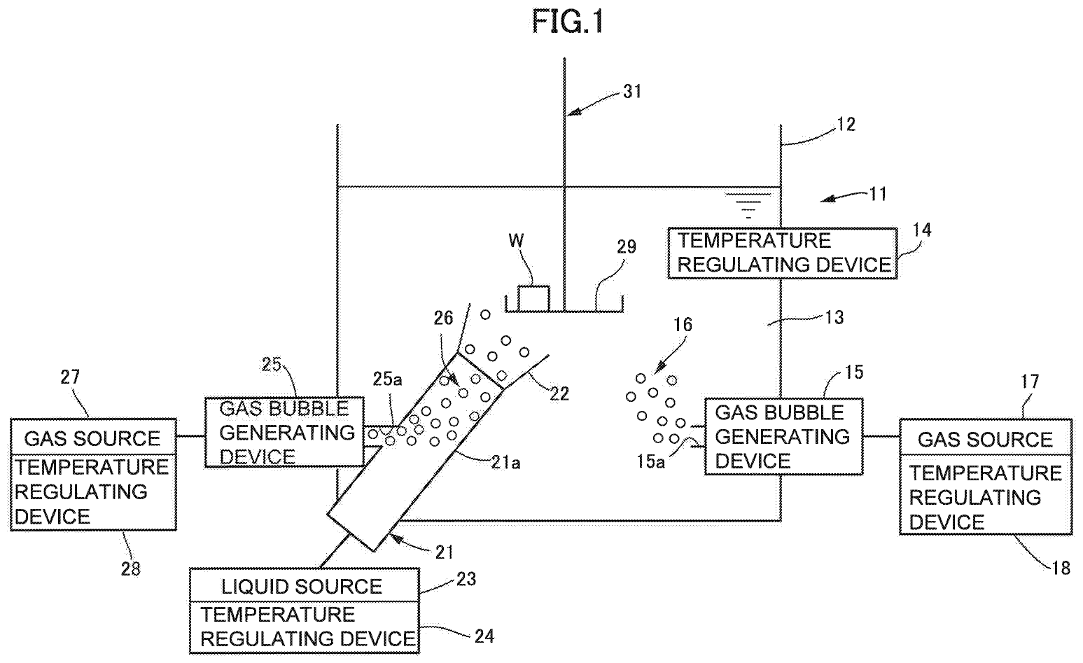

FIG. 1 shows an overall picture of a cleaning device related to a first embodiment of the present invention. The cleaning device 11 includes a liquid tank 12. The liquid tank 12 is filled with a liquid (hereinafter, called a ‘static liquid’) 13. The static liquid 13 may employ not only pure water but also a liquid that uses water or an organic solvent as a solvent and has an electrolyte, a surfactant, a gas, etc. dissolved therein. In the static liquid 13, natural convection based on temperature distribution is allowed, but it is desirable to exclude forced movement of the liquid by power.

A first temperature regulating device 14 is connected to the liquid tank 12. The first temperature regulating device 14 includes for example a heat exchanger that is immersed in the static liquid 13. The first temperature regulating device 14 regulates a temperature TL of the static liquid 13 within the liquid tank 12. When regulating the temperature TL, thermal energy is added to the static liquid 13 from the first temperature regulating device 14 (or the static liquid 13 is deprived thereof). Thermal energy (either plus or minus) may be transferred to the static liquid 13 by any method. The temperature of the static liquid 13 is desirably set at no greater than 80 degrees Celsius. When the liquid is for example pure water or an aqueous solution, if the temperature of the pure water or the aqueous solution exceeds 80 degrees Celsius, the gas bubbles cannot maintain a high number density in a stable manner.

A first gas bubble generating device 15 is connected to the liquid tank 12. The first gas bubble generating device 15 has a supply port 15a opening in the static liquid 13. The first gas bubble generating device 15 blows fine gas bubbles into the static liquid 13 via the supply port 15a. A flow of a first fine gas bubble group 16 is formed in the static liquid 13. The fine gas bubbles include microbubbles and nanobubbles (=ultrafine bubbles). The first fine gas bubble group 16 may be a collection of gas bubbles having an average diameter D1 of a defined value or less. The diameter of the gas bubbles may be set based on the diameter of a fine hole provided in the supply port 15a. The diameter of the fine hole is set at at least 100 nm and no greater than 50 μm. The diameter D1 of the gas bubbles is preferably no greater than 1000 nm (1 μm). The concentration of the gas bubbles having a diameter of at least 100 nm and no greater than 50 μm is desirably 0.5×10⁶ or greater per milliliter.

A gas source 17 is connected to the first gas bubble generating device 15. The gas source 17 supplies a gas to the first gas bubble generating device 15. The gas is not limited to air, nitrogen, hydrogen, etc. and may be any type of gas. A second temperature regulating device 18 is connected to the gas source 17. The second temperature regulating device 18 regulates a temperature T1 of the gas of the gas source 17. When regulating the temperature in this way, thermal energy is added to the gas from the second temperature regulating device 18 (or the gas is deprived thereof). Thermal energy (either plus or minus) may be transferred to the gas by any method. Here, by virtue of the second temperature regulating device 18 the temperature T1 of the gas is set to be equal to the temperature TL of the static liquid 13.

A liquid flow generating device 21 is connected to the liquid tank 12. The liquid flow generating device 21 has a liquid pipe 21a opening in the static liquid 13. The liquid pipe 21a is formed from for example a cylindrical pipe having a linear axis. The liquid flow generating device 21 makes a liquid flow into the static liquid 13 via the extremity of the liquid pipe 21a. The flow rate (flow volume) is set at 3.0 to 30.0 L/min. In this way, a liquid flow (hereinafter, called a ‘dynamic liquid’) 22 is formed in the static liquid 13. The dynamic liquid 22 includes a liquid that forcibly generates relative movement with respect to the static liquid 13. Such forced relative movement may be achieved in the form of a jet by means of an impeller.

A liquid source 23 is connected to the liquid flow generating device 21. The liquid source 23 supplies a liquid to the liquid flow generating device 21. The liquid may be the same liquid as the static liquid 13. A third temperature regulating device 24 is connected to the liquid source 23. The third temperature regulating device 24 regulates the temperature of the liquid of the liquid source 23. When regulating the temperature in this way, thermal energy is added to the liquid from the third temperature regulating device 24 (or the liquid is deprived thereof). Thermal energy (either plus or minus) may be transferred to the liquid by any method. Here, by virtue of the third temperature regulating device 24 the temperature TD of the dynamic liquid 22 is set at for example a higher temperature than the temperature TL of the static liquid.

A second gas bubble generating device 25 is connected to the liquid pipe 21a of the liquid flow generating device 21. The second gas bubble generating device 25 has a supply port 25a opening within the liquid pipe 21a. The second gas bubble generating device 25 blows fine gas bubbles into the dynamic liquid 22 via the supply port 25a. The fine gas bubbles are entrapped by the dynamic liquid 22 within the liquid pipe 21a, thus forming a flow of a second fine gas bubble group 26. The fine gas bubbles include microbubbles and nanobubbles. The second fine gas bubble group 26 may be a collection of gas bubbles having an average diameter D2 that is smaller than the average diameter D1 of the first fine gas bubble group 16. The diameter D2 of gas bubbles may be set based on the diameter of a fine hole provided in the supply port 25a. The diameter of the fine hole is set at no greater than 100 nm. The diameter of the fine hole may preferably be no greater than 50 nm. The concentration of the gas bubbles having a diameter of no greater than 100 nm is desirably 1×10⁶ or greater per milliliter. The concentration of gas bubbles of the second fine gas bubble group 26 is preferably larger than the concentration of gas bubbles of the first fine gas bubble group 16. Since the supply port 25a of the second gas bubble generating device 25 opens within the liquid pipe 21a, the dynamic liquid 22 is capable of reliably containing a defined amount of the second fine gas bubble group compared with a case in which fine gas bubbles are entrapped by a dynamic liquid issuing from the liquid pipe 21a.

A gas source 27 is connected to the second gas bubble generating device 25. The gas source 27 supplies a gas to the second gas bubble generating device 25. The gas is not limited to air, nitrogen, hydrogen, etc. and may be any type of gas. A fourth temperature regulating device 28 is connected to the gas source 27. The fourth temperature regulating device 28 regulates the temperature of the gas of the gas source 27. When regulating the temperature in this way, thermal energy is added to the gas from the fourth temperature regulating device 28 (or the gas is deprived thereof). Thermal energy (either plus or minus) may be transferred to the gas by any method. Here, by virtue of the fourth temperature regulating device 28 a temperature T2 of the gas is set at a temperature that is higher than the temperature of the dynamic liquid 22.

The cleaning device 11 has a holder 29 for holding an object to be cleaned W. The holder 29 may employ for example a basket. The holder 29 is immersed in the static liquid 13. The object to be cleaned W is fixed to the holder 29. The object to be cleaned W is held in the static liquid 13. The opening of the liquid pipe 21a is directed toward the object to be cleaned W on the holder 29. That is, the object to be cleaned W is disposed on an extension line of the axis of the liquid pipe 21a. In this way, a liquid flow is generated toward the object to be cleaned W.

A positioning mechanism 31 may be connected to the holder 29. The positioning mechanism 31 exerts a driving force that generates for example movement of the holder 29 along a horizontal plane. In accordance with such movement of the holder 29, the dynamic liquid 22 and the first fine gas bubble group 16 can be directed to a target position on the object to be cleaned W. Cleaning of a face to be cleaned can be realized over a wide range. In addition, instead of the holder 29 being driven, the liquid tank 12 may be moved relative to the fixed holder 29. Alternatively, the orientation of the liquid pipe 21a or the orientation of the supply port 15a may be changed with respect to the fixed holder 29 and liquid tank 12.

When the cleaning device 11 operates, the first gas bubble generating device 15 blows the first fine gas bubble group 16 at a first temperature into the static liquid 13 at the first temperature. The liquid flow generating device 21 generates a liquid flow having a second temperature that is higher than the first temperature toward the object to be cleaned W. The dynamic liquid 22 is generated in the static liquid 13. The second gas bubble generating device 25 blows the second fine gas bubble group 26 at a third temperature that is higher than the second temperature into the liquid within the liquid pipe 21a. The second fine gas bubble group 26 thus blown out is entrapped by the dynamic liquid 22. In this way, the cleaning liquid related to the present embodiment is generated in accordance with a combination of the static liquid 13, the first fine gas bubble group 16, the dynamic liquid 22 and the second fine gas bubble group 26. Here, for example the first temperature of the first fine gas bubble group 16 is set at 30 degrees Celsius and the second temperature of the second fine gas bubble group 26 is set at 60 degrees Celsius.

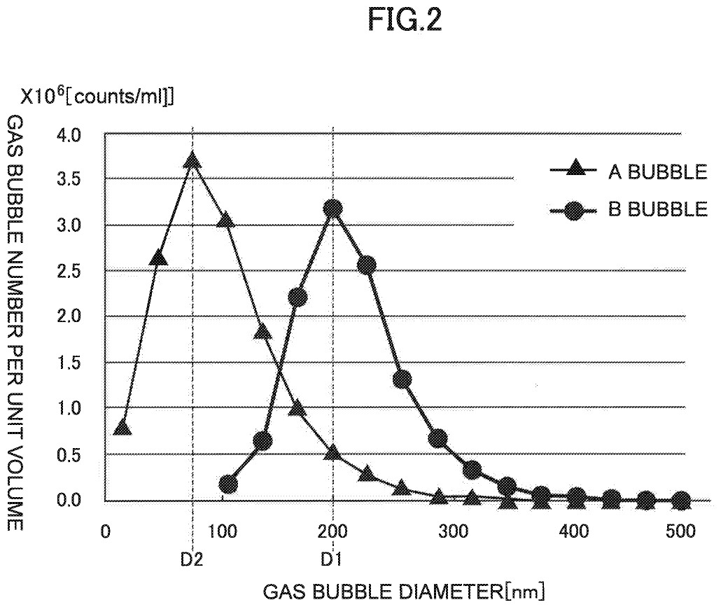

As shown in FIG. 2, the first fine gas bubble group 16 has an average gas bubble diameter of the first diameter D1 (=at least 100 nm and no greater than 50 μm). The first gas bubble generating device 15 blows out fine gas bubbles with the maximum number [counts] at the first diameter D1. As the gas bubble diameter increases or decreases from the first diameter D1, the number of gas bubbles [counts] decreases. That is, the number distribution has a peak at the first diameter D1 (=about 200 nm). On the other hand, the second fine gas bubble group 26 has an average gas bubble diameter of the second diameter D2 (=less than 100 nm). The second gas bubble generating device 25 blows out fine gas bubbles with the maximum number at the second diameter D2. As the gas bubble diameter increases or decreases from the second diameter D2, the number of gas bubbles decreases. That is, the number distribution has a peak at the second diameter D2 (=about 80 nm). The gas bubble number [counts] per unit volume of the first fine gas bubble group 16 is no greater than 75% of the total gas bubble number. The gas bubble number [counts] per unit volume of the second fine gas bubble group 26 is at least 25% of the total gas bubble number.

The second fine gas bubble group 26 and the first fine gas bubble group 16 thus blown out collide with the object to be cleaned W. Fine gas bubbles having different temperatures make contact one after another with the border (the contour of the interface) between the surface of the object to be cleaned W and a contaminant. Due to the fine gas bubbles having different temperatures acting on the same position, a repeated temperature change occurs at the contour of the interface (temperature oscillation). The temperature oscillation causes detachment at the interface. Fine gas bubbles penetrate into the inside from the contour accompanying the progress of detachment. In this way, the contaminant becomes detached from the surface of the object to be cleaned W. The contaminant is separated from the object to be cleaned W. By virtue of such temperature oscillation, the cleaning liquid exhibits a cleaning effect remarkably better than ever before without necessarily utilizing the energy of collapsing gas bubbles. The temperature of the static liquid 13 may be set freely to be at least the second temperature but no greater than the first temperature. When the static liquid 13 is for example pure water or an aqueous solution, the temperature of the liquid 53 is desirably set at no greater than 80 degrees Celsius. If the temperature of the pure water or the aqueous solution exceeds 80 degrees Celsius, the gas bubbles cannot maintain a high numerical density in a stable manner.

Due to the difference between the first temperature and the third temperature the temperature changes locally within the fine gas bubbles of the second fine gas bubble group 26. The local temperature change triggers local variation in volume within the fine gas bubbles, as a result more distortion than usual is generated in the fine gas bubbles, and the fine gas bubbles change significantly into a non-spherical shape. Compared with spherical fine gas bubbles, the non-spherical fine gas bubbles easily enter the border (the contour of the interface) between the surface of the object to be cleaned W and a substance (for example a contaminant) adhering to the surface of the object to be cleaned W. Detachment at the interface is thus promoted. Gas penetrates into the inside from the contour accompanying the progress of detachment. The substance becomes detached from the surface of the object. The substance is separated from the object to be cleaned W. Furthermore, it is thought that, compared with spherical fine gas bubbles, non-spherical fine gas bubbles have an uneven local surface energy distribution due to the non-spherical shape, and the chemical bonding force between the non-spherical fine gas bubbles and the substance (for example a contaminant) adhering to the surface of the object to be cleaned W is therefore great. As a result, the fine gas bubbles form an adsorbing body between themselves and the adhering substance, thus promoting the detachment from the surface of the object to be cleaned W. In this way, the substance becomes detached from the surface of the object to be cleaned W. The substance is separated from the object to be cleaned W.

### (2) Cleaning Device Related to Second Embodiment

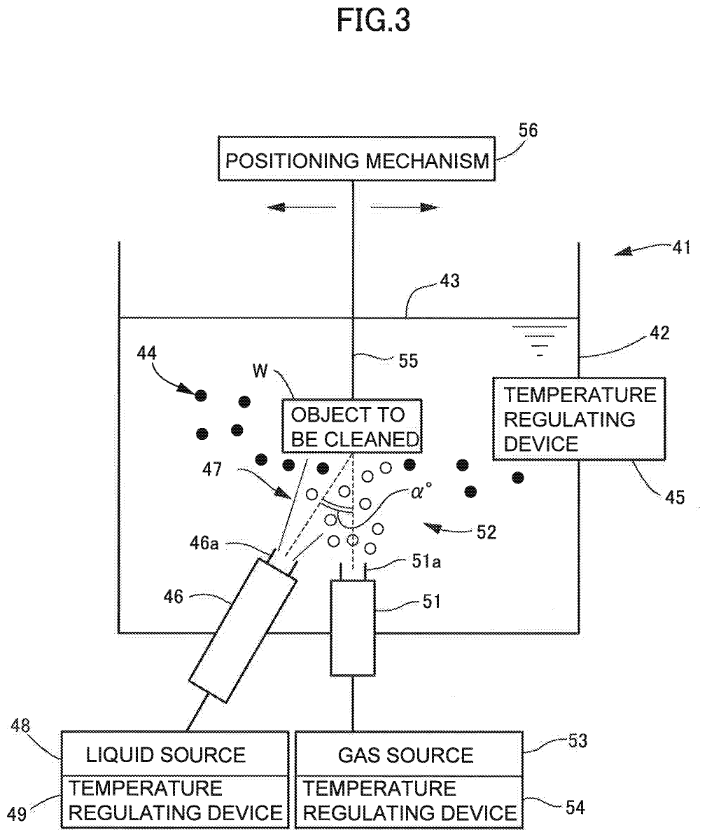

FIG. 3 shows an overall picture of a cleaning device related to a second embodiment of the present invention. The cleaning device 41 includes a liquid tank 42. The liquid tank 42 is filled with a liquid (hereinafter, called a ‘static liquid’) 43. The static liquid 43 may employ not only pure water but also a liquid that uses water or an organic solvent as a solvent and has an electrolyte, a surfactant, a gas, etc. dissolved therein. In the static liquid 43, natural convection based on temperature distribution is allowed, but it is desirable to exclude forced movement of the liquid by power.

The static liquid 43 includes a first fine gas bubble group 44. The first fine gas bubble group 44 includes microbubbles and nanobubbles (=ultrafine bubbles). The first fine gas bubble group 44 may be a collection of gas bubbles having an average diameter D1 of a defined value or less. The average diameter D1 is set at at least 100 nm and no greater than 50 μm. The average diameter D1 is preferably no greater than 1000 nm (=1 μm). The gas is not limited to air, nitrogen, hydrogen, etc. and may be any type of gas. The concentration of gas babbles of the first fine gas bubble group 44 is desirably at least 0.5×10⁶ counts per milliliter.

A first temperature regulating device 45 is connected to the liquid tank 42. The first temperature regulating device 45 includes for example a heat exchanger that is immersed in the static liquid 43. The first temperature regulating device 45 regulates a temperature TL of the static liquid 43 within the liquid tank 42. When regulating the temperature TL, thermal energy is added to the static liquid 43 from the first temperature regulating device 45 (or the static liquid 43 is deprived thereof). Thermal energy (either plus or minus) may be transferred to the static liquid 43 by any method. Here, the thermal energy is equilibrated between the first fine gas bubble group 44 in the static liquid 43 and the static liquid 43. Therefore, a temperature T1 of gas contained in each fine gas bubble can be assumed to be equal to the temperature TL measured as the static liquid 43. The temperature of the static liquid 43 is desirably set at no greater than 80 degrees Celsius. When the liquid is for example pure water or an aqueous solution, if the temperature of the pure water or the aqueous solution exceeds 80 degrees Celsius, the gas bubbles cannot maintain a high number density in a stable manner.

A liquid flow generating device 46 is connected to the liquid tank 42. The liquid flow generating device 46 has a supply port 46a opening in the static liquid 43. The liquid flow generating device 46 makes a liquid flow into the static liquid 43 via the supply port 46a. In this way, a liquid flow (hereinafter, called a ‘dynamic liquid’) 47 is formed in the static liquid 13. The dynamic liquid 47 includes a liquid that forcibly generates relative movement with respect to the static liquid 43. Such forced relative movement may be achieved in the form of a jet by means of an impeller.

A liquid source 48 is connected to the liquid flow generating device 46. The liquid source 48 supplies a liquid to the liquid flow generating device 46. The liquid may be the same liquid as the static liquid 43. A second temperature regulating device 49 is connected to the liquid source 48. The second temperature regulating device 49 regulates the temperature of the liquid of the liquid source 48. When regulating the temperature in this way, thermal energy is added to the liquid from the second temperature regulating device 49 (or the liquid is deprived thereof). Thermal energy (either plus or minus) may be transferred to the liquid by any method. Here, by virtue of the second temperature regulating device 49 the temperature of the dynamic liquid 47 is set at the same temperature as for the static liquid 43.

A gas bubble generating device 51 is connected to the liquid tank 42. The gas bubble generating device 51 has a supply port 51a opening in the static liquid 43. The gas bubble generating device 51 blows fine gas bubbles into the static liquid 43 via the supply port 51a. A flow of a second fine gas bubble group 52 is formed in the static liquid 43. The fine gas bubbles include microbubbles and nanobubbles. The second fine gas bubble group 52 may be a collection of gas bubbles having an average diameter D2 that is smaller than the average diameter D1 of the first fine gas bubble group 44. The diameter D2 of the gas bubbles may be set based on the diameter of a fine hole provided in the supply port 51a. The diameter of the fine hole is set at less than 100 nm. The diameter of the fine hole is preferably no greater than 50 nm. The concentration of the gas bubbles having a diameter of less than 100 nm is desirably 1×10⁶ or greater per milliliter.

A gas source 53 is connected to the gas bubble generating device 51. The gas source 53 supplies a gas to the gas bubble generating device 51. The gas is not limited to air, nitrogen, hydrogen, etc. and may be any type of gas. A third temperature regulating device 54 is connected to the gas source 53. The third temperature regulating device 54 regulates the temperature of the gas of the gas source 53. When regulating the temperature in this way, thermal energy is added to the gas from the third temperature regulating device 54 (or the gas is deprived thereof). Thermal energy (either plus or minus) may be transferred to the gas by any method. Here, by virtue of the third temperature regulating device 54 a temperature H2 of the gas is set at a temperature (=second temperature H2) that is higher than the temperature of the first fine gas bubble group 44. The second temperature H2 is set at for example 60 degrees Celsius.

The cleaning device 11 has a holder 55 for holding an object to be cleaned W. The holder 55 is immersed in the static liquid 43. The object to be cleaned W is fixed to the extremity of the holder 55. The object to be cleaned W is held in the static liquid 43. The supply port 46a of the liquid flow generating device 46 is directed toward the object to be cleaned W on the holder 55. In this way, a liquid flow is generated toward the object to be cleaned W. The supply port 51a of the gas bubbles generating device 51 is similarly directed to the object to be cleaned W on the holder 55. In this way, a flow of the second fine gas bubble group 52 toward the object to be cleaned W is generated. Here, it is desirable for a vector showing the direction of the liquid flow and a vector showing the direction of the flow of the second fine gas bubble group 52 to intersect each other on the object to be cleaned W at an acute angle. More preferably, it is desired for an angle α of the two vectors to be less than 90°. In accordance with such an angle α, the second fine gas bubble group 52 can easily be entrapped by the liquid flow and reach the object to be cleaned W. In addition, the angle α may be set to a value that can realize entrapment of the second fine gas bubble group 52 by the liquid flow according to the flow rate of the liquid flow and the flow rate of the second fine gas bubble group 52. The flow of the second fine gas bubble group 52 may be set to be vertically upward (a direction opposite to the direction of gravity).

A positioning mechanism 56 may be connected to the holder 55. The positioning mechanism 56 exerts a driving force that generates for example movement of the holder 55 along a horizontal plane. In accordance with such movement of the holder 55, the dynamic liquid 47 and the second fine gas bubble group 52 can be directed to a target position on the object to be cleaned W. Cleaning of a face to be cleaned can be realized over a wide range. In addition, instead of the holder 55 being driven, the liquid tank 42 may be moved relative to the fixed holder 55. Alternatively, the orientation of the supply ports 46a and 51a may be changed with respect to the fixed holder 55 and liquid tank 42.

When the cleaning device 41 operates, the liquid flow generating device 46 generates a liquid flow toward the object to be cleaned W. The dynamic liquid 47 is generated in the static liquid 43. The gas bubble generating device 51 blows out the second fine gas bubble group 52 at a temperature that is higher than the temperature of the static liquid 43 toward the object to be cleaned W. The second fine gas bubble group 52 thus blown out is entrapped by the flow of the dynamic liquid 47. In this way, the cleaning fluid of this embodiment is generated in accordance with a combination of the static liquid 43 containing the first fine gas bubble group 44, the dynamic liquid 47 and the second fine gas bubble group 52.

Since the surface (face to be cleaned) of the object to be cleaned W is in contact with the static liquid 43, the temperature of the surface of the object to be cleaned W increases accompanying an increase in the temperature of the static liquid 43. Due to the difference between the temperature of the static liquid 43 and the temperature of the second fine gas bubble group 52 the temperature changes locally within the fine gas bubbles. The local temperature change triggers local variation in volume within the fine gas bubbles, as a result more distortion than usual is generated in the fine gas bubbles, and the fine gas bubbles change significantly into a non-spherical shape. When such fine gas bubbles of the second fine gas bubble group 52 make contact with the surface of the object to be cleaned W, compared with spherical fine gas bubbles, the non-spherical fine gas bubbles easily enter the border (the contour of the interface) between the surface of the object to be cleaned W and a substance (for example a contaminant) adhering to the surface of the object to be cleaned W. Detachment at the interface is thus promoted. Gas penetrates into the inside from the contour accompanying the progress of detachment. The substance becomes detached from the surface of the object. The substance is separated from the object to be cleaned W. Furthermore, it is thought that, compared with spherical fine gas bubbles, non-spherical fine gas bubbles have an uneven local surface energy distribution due to the non-spherical shape, and the chemical bonding force between the non-spherical fine gas bubbles and the substance (for example a contaminant) adhering to the surface of the object to be cleaned W is therefore great. As a result, the fine gas bubbles form an adsorbing body with the adhering substance, thus promoting the detachment from the surface of the object to be cleaned W. In this way, the substance becomes detached from the surface of the object to be cleaned W. The substance is separated from the object to be cleaned W.

### (3) Verification

The present inventors have carried out verification in accordance with the cleaning device 41 related to the second embodiment. In the verification, temperature conditions were examined for the static liquid 43, the dynamic liquid 47 and the second fine gas bubble group 52. The static liquid 43 employed pure water. For the examination, the liquid tank 42 was filled with 50 L of pure water. The temperature (=TL) of the pure water was regulated. Pure water was supplied to the liquid flow generating device 46 from the liquid source 48. The temperature (first temperature T1) of the dynamic liquid 47 was regulated. The flow rate of the dynamic liquid 47 was set at 20.0 L/min.

Atmosphere (air) was supplied to the gas bubble generating device 51 from the gas source 53. The temperature (second temperature T2) of the air was regulated. The amount of fine gas bubbles was regulated. The diameter of the fine gas bubbles was regulated. The second fine gas bubble group 52 was continuously blown into the dynamic liquid 47 over 10 minutes.

The holder 55 employed a basket. A machine component was mounted in the basket as the object to be cleaned W. Swarf at the time of machining became attached to the surface of the machine component together with oil. After carrying out cleaning for 10 minutes, the amount of swarf and the amount of oil remaining on the surface of the machine component were measured. When measuring the amount of swarf, the machine component cleaned as above was subjected to high pressure cleaning. Swarf thus washed away was collected on a filter paper. The weight [milligrams] of swarf thus collected was measured using an electronic balance. On the other hand, when measuring the amount of oil, the cleaned machine component was immersed in a solvent. The concentration [ppm] of oil dissolved in the solvent was measured.

When examining the temperature conditions, three types of conditions were set as follows.

TABLE 1

| | | | Temperature |
|---|---|---|---|
| | | | T2 of |
| | Temperature | Temperature | second |
| | TL of | TD of | fine gas |
| | static | dynamic | bubble |
| | liquid | liquid | group |
| Conditions 1 | 15° C. | 25° C. | 25° C. |
| Conditions 2 | 50° C. | 40° C. | 60° C. |
| Conditions 3 | 30° C. | 40° C. | 60° C. |
| Conditions 4 | 30° C. | 40° C. | 60° C. |
| Conditions 5 | 30° C. | 40° C. | 60° C. |
| Conditions 6 | 30° C. | 40° C. | 60° C. |

In Conditions 1 the temperature TD of the dynamic liquid 47 was set to be higher than the temperature TL of the static liquid 43. The temperature T2 of the second fine gas bubble group 52 was set to be equal to the temperature TD of the dynamic liquid 47. In Conditions 2 the temperature TD of the dynamic liquid 47 was set to be lower than the temperature TL of the static liquid 43. The temperature T2 of the second fine gas bubble group 52 was set to be higher than the temperature TL of the static liquid 43. In Conditions 3, Conditions 4, Conditions 5 and Conditions 6, the temperature TD of the dynamic liquid 47 was set to be higher than the temperature TL of the static liquid 43. The temperature T2 of the second fine gas bubble group 52 was set to be higher than the temperature TD of the dynamic liquid 47.

When examining the temperature conditions, the present inventors set comparative Conditions. In the comparative Conditions the temperature TL of the static liquid 43, the temperature TD of the dynamic liquid 47, and the temperature T2 of the second fine gas bubble group 52 were set to be equal at 25 degree Celsius.

TABLE 2

| | | | Temperature |
|---|---|---|---|
| | | | T2 of |
| | Temperature | Temperature | second |
| | TL of | TD of | fine gas |
| | static | dynamic | bubble |
| | liquid | liquid | group |
| Comparative | 25° C. | 25° C. | 25° C. |
| Conditions 1 | | | |

At the same time the present inventors examined the relationship between the average diameter of the first fine gas bubble group 44 and the second fine gas bubble group 52, the amount of gas bubbles (gas bubble density), and the cleaning effect. As described below five types of conditions were set.

TABLE 3

| | First fine gas bubble group | | Second fine gas bubble group | |
|---|---|---|---|---|
| | Average | Amount of gas bubbles | Average | Amount of gas bubbles |
| | diameter [nm] | [counts/milliliter] | diameter [nm] | [counts/milliliter] |
| Conditions 1 | 200 | 1 × 10⁶ | 200 | 1 × 10⁶ |
| Conditions 2 | 200 | 1 × 10⁶ | 200 | 1 × 10⁶ |
| Conditions 3 | 200 | 1.5 × 10⁶ | 50 | 0.5 × 10⁶ |
| Conditions 4 | 200 | 1.0 × 10⁶ | 50 | 1.0 × 10⁶ |
| Conditions 5 | 50 | 0.6 × 10⁶ | 200 | 1.4 × 10⁶ |
| Conditions 6 | 200 | 0.6 × 10⁶ | 50 | 1.4 × 10⁶ |

TABLE 4

| | First fine gas bubble group | | Second fine gas bubble group | |
|---|---|---|---|---|
| | Average | Amount of gas bubbles | Average | Amount of gas bubbles |
| | diameter [nm] | [counts/milliliter] | diameter [nm] | [counts/milliliter] |
| Comparative | 200 | 1 × 10⁶ | 200 | 1 × 10⁶ |
| Conditions 1 | | | | |

In Conditions 1 and Conditions 2 the average diameter [nm] and the amount of gas bubbles [counts/milliliter] of the first fine gas bubble group 44 and the second fine gas bubble group 52 were set to be equal. In Conditions 3, Conditions 4 and Conditions 6, the average diameter of the second fine gas bubble group 52 was set to be smaller than the average diameter of the first fine gas bubble group 44. In Conditions 5 the average diameter of the second fine gas bubble group 52 was set to be larger than the average diameter of the first fine gas bubble group 44. In Conditions 5, a relationship that was opposite to that in Conditions 3, Conditions 4 and Conditions 6 was established. In Conditions 3 the amount of gas bubbles of the first fine gas bubble group 44 and the second fine gas bubble group 52 was set to be 75:25. In Conditions 4 the amount of gas bubbles of the first fine gas bubble group 44 and the second fine gas bubble group 52 was set to be 50:50. In Conditions 5 and Conditions 6 the amount of gas bubbles of the first fine gas bubble group 44 and the second fine gas bubble group 52 was set to be 30:70.

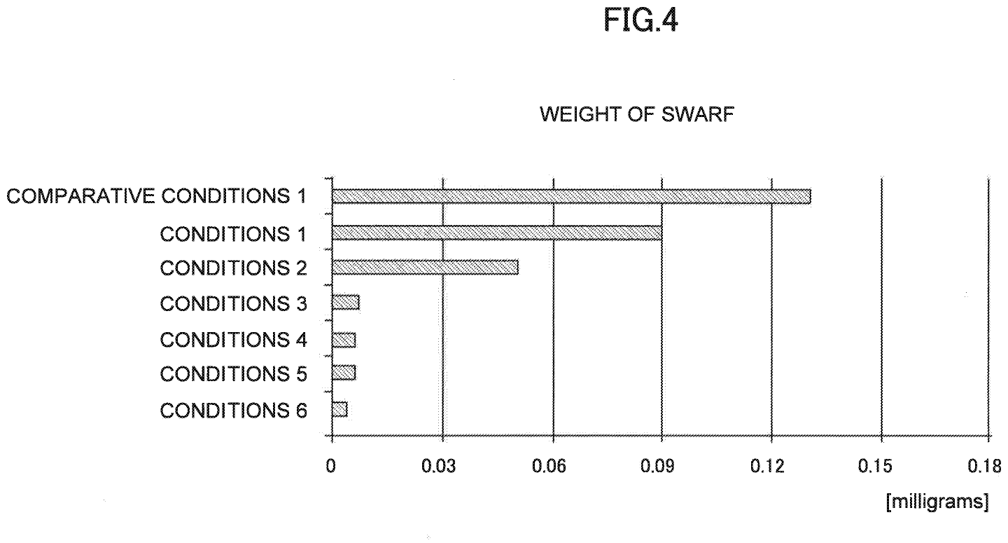

As a result of the examination, as shown in FIG. 4, it has been confirmed by comparing Conditions 1 and Conditions 2 with comparative Conditions 1 that removal of swarf is promoted when a difference in temperature between the static liquid 43 and the dynamic liquid 47 occurs. In particular, as is clear from a comparison between Conditions 1 and Conditions 2, it has been confirmed that removal of swarf is promoted when the temperature TL of the static liquid 43 and the temperature TD of the dynamic liquid 47 are high even if the difference in temperature is equal. Furthermore, as shown in Conditions 3 to 6, it has been confirmed that removal of swarf is greatly promoted when a difference is given to the average diameter between the first fine gas bubble group 44 and the second fine gas bubble group 52. In particular, as is clear from a comparison between Conditions 3, Conditions 4 and Conditions 6, it has been confirmed that the further beyond 25% the proportion of the second fine gas bubble group 52 with a small average diameter is, the more the removal of swarf is promoted.

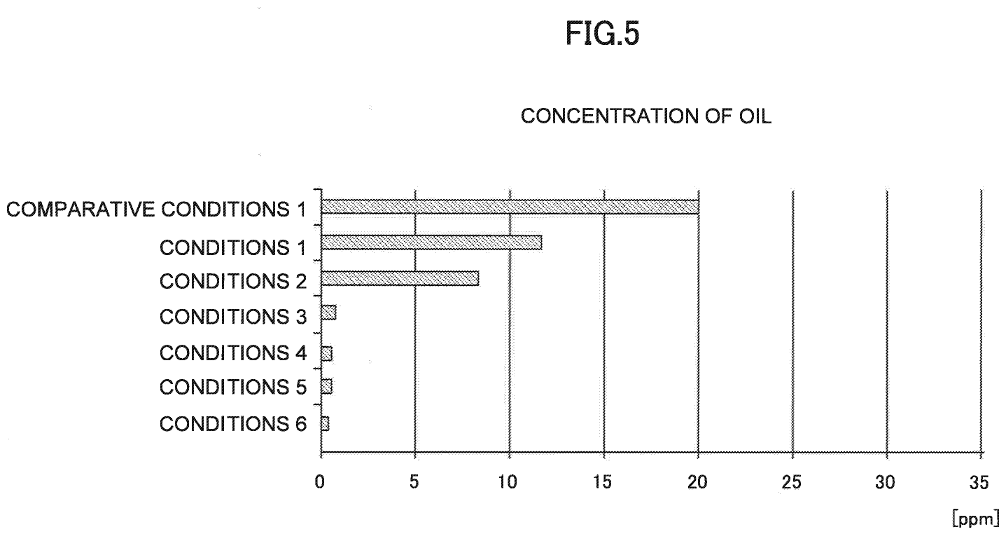

As shown in FIG. 5, it has been confirmed by comparing Conditions 1 and Conditions 2 with comparative Conditions 1 that removal of oil is promoted when a difference in temperature between the static liquid 43 and the dynamic liquid 47 occurs. In particular, as is clear from a comparison between Conditions 1 and Conditions 2, it has been confirmed that removal of oil is promoted when the temperature TL of the static liquid 43 and the temperature TD of the dynamic liquid 47 are high even if the difference in temperature is equal. Furthermore, as shown in Conditions 3 to 6, it has been confirmed that removal of oil is greatly promoted when a difference is given to the average diameter between the first fine gas bubble group 44 and the second fine gas bubble group 52. In particular, as is clear from a comparison between Conditions 3, Conditions 4 and Conditions 6, it has been confirmed that the further beyond 25% the proportion of the second fine gas bubble group 52 with a small average diameter is, the more the removal of oil is promoted.

1. A cleaning liquid comprising
a static liquid,
a first fine gas bubble group contained in the static liquid and formed by a gas at a first temperature,
a dynamic liquid that flows toward an object held in the static liquid, and
a second fine gas bubble group formed by a gas at a second temperature that is different from the first temperature, the second fine gas bubble group being entrapped by a flow of the dynamic liquid and flowing toward the object.

2. The cleaning liquid according to claim 1, wherein the first fine gas bubble group has an average gas bubble diameter of a first diameter, and the second fine gas bubble group has an average gas bubble diameter of a second diameter that is different from the first diameter.

3. The cleaning liquid according to claim 2, wherein the average gas bubble diameter of one of the first fine gas bubble group and the second fine gas bubble group is less than 100 nm, and the average gas bubble diameter of the other is at least 100 nm and no greater than 50 μm.

4. The cleaning liquid according to claim 3, wherein the gas bubble number of the second fine gas bubble group is at least 25% of a total gas bubble number per unit volume.
